(19) United States
(12) Patent Application Publication
(10) Pub. No.: US 2008/0136263 A1
(43) Pub. Date: Jun. 12, 2008

(54) POWER SUPPLY SYSTEM

(75) Inventors: Yoshihiro Kaneda, Kawasaki-shi (JP); Takashi Sekiguchi, Kawasaki-shi (JP); Takao Sumiya, Kawasaki-shi (JP); Yoshihiro Onoda, Kawasaki-shi (JP); Takuya Suemura, Kawasaki-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/942,894

(22) Filed: Nov. 20, 2007

(30) Foreign Application Priority Data
Dec. 6, 2006 (JP) 2006-329272

(51) Int. Cl. H02J 1/00

(52) U.S. Cl. 307/80

(57) ABSTRACT

A power supply system for supplying a plurality of power-supply voltages to a load. The power supply system includes: a plurality of voltage output units which output the plurality of power-supply voltages; a gradient calculation unit which calculates the gradients of the plurality of power-supply voltages in intervals subsequent to certain moments immediately after the beginnings of rises of the plurality of power-supply voltages on the basis of the levels of the plurality of power-supply voltages at the moments; a gradient extraction unit which extracts the gentlest one of the gradients; and a power-supply control unit which controls the plurality of voltage output units so that the plurality of power-supply voltages rise with the gentlest one of the gradients.

### CROSS-REFERENCE TO RELATED APPLICATIONS

This application is based upon and claims the benefits of priority from the prior Japanese Patent Application No. 2006-329272, filed on Dec. 6, 2006, the entire contents of which are incorporated herein by reference.

### BACKGROUND OF THE INVENTION

1) Field of the Invention

The present invention relates to a power supply system which supplies a plurality of power-supply voltages to a load.

2) Description of the Related Art

Some types of semiconductor devices such as FPGAs (Field Programmable Gate Arrays) need a plurality of different power-supply voltages.

FIG. 16 is a diagram illustrating an example of a configuration for supplying a plurality of different power-supply voltages to a load which needs such power-supply voltages. In FIG. 16, reference number 101 denotes a load, 111 to 113 each denote an on-board power supply (OBP), and 121 to 123 each denote a group of capacitors.

The load 101 is a one-chip semiconductor device such as an FPGA. The OBPs 111 to 113 respectively supply different power-supply voltages Vin1 to Vin3 to the load 101, and each of the OBPs 111 to 113 is realized by, for example, a one-chip semiconductor device. The groups 121 to 123 of capacitors are respectively connected to power-input terminals of the load 101, through which the power-supply voltages Vin1 to Vin3 are supplied to the load 101, respectively. The number of capacitors in each of the groups 121 to 123 is determined, for example, on the basis of the load characteristics (such as the magnitudes and variations of the currents I1 to I3 which flow from the OBPs 111 to 113 to the load 101).

The starting times of power supplies are specified for some types of semiconductor devices which are currently used. For example, it is specified that the OBPs 111 to 113 start in succession at intervals of 200 microseconds so that the power-supply voltages Vin1 to Vin3 supplied to the load 101 reach the desired levels in succession.

FIG. 17 is a diagram provided for explaining the starting times of the power-supply voltages, and shows examples of rises of the power-supply voltages Vin1 to Vin3 outputted from the OBPs 111 to 113 in FIG. 16. As indicated in FIG. 17, the gradients of the power-supply voltages Vin1 to Vin3 are different from each other, and determined by the output characteristics of the OBPs 111 to 113, the capacitances of the groups of capacitors 121 to 123, the load characteristics of the load 101, and the like.

Assume that the specification of the load 101 requires that the power-supply voltages Vin1 to Vin3 rise in the order of Vin1, Vin2, and Vin3. However, the difference between the gradients of the power-supply voltages Vin1 to Vin3 can make the power-supply voltage Vin3 reach a desired level before the power-supply voltage Vin1 reaches a desired level.

In order to overcome the above problem and equalize the gradients of the power-supply voltages outputted from the OBPs 111 to 113 during the rises of the power-supply voltages, some types of the conventional OBPs are provided with a tracing function of monitoring a reference voltage, and outputting a voltage identical to the reference voltage since each OBP starts up until the voltage outputted from the OBP reaches a desired level.

FIG. 18 is a diagram illustrating an example of a circuit in which OBPs have the tracing function. Elements in FIG. 18 similar to the corresponding elements in FIG. 16 bear the same reference numbers as the corresponding elements in FIG. 16.

In the configuration of FIG. 18, the OBPs 131 and 132 have the tracing function, so that the OBPs 131 and 132 output the power-supply voltages Vin1 and Vin2 by tracing (following) the power-supply voltage Vin3 of the OBP 133. Therefore, in order to equalize the gradients, it is necessary that the gradient of the power-supply voltage Vin3 outputted from the OBP 133 is gentlest (condition 1), and the level of the power-supply voltage Vin3 is highest among the power-supply voltages Vin1, Vin2, and Vin3 (condition 2) for the following reasons.

Generally, the gradient can be made gentler, and cannot be made steeper. That is, when the gradient of the power-supply voltage Vin3 is steeper than the gradients of the power-supply voltages Vin1 and Vin2, it is impossible to make the gradients of the power-supply voltages Vin1 and Vin2 steeper and equalize the gradients of the power-supply voltages Vin1 to Vin3.

In addition, each of the OBPs 131 to 133 can trace (follow) a voltage higher than the voltage which the OBP outputs, and cannot trace a voltage lower than the voltage which the OBP outputs. That is, when the level of the power-supply voltage Vin3 to be traced is lower than the levels of the power-supply voltages Vin1 and Vin2, the power-supply voltages Vin1 and Vin2 are clamped.

FIG. 19 is a diagram provided for explaining the tracing function, and shows rises of the power-supply voltages Vin1 to Vin3 outputted from the OBPs 131 to 133 in FIG. 18. As indicated in FIG. 19, it is assumed that the gradient of the power-supply voltage Vin3 is steepest.

In the case of FIG. 19, since the gradients of the power-supply voltages Vin1 and Vin2 are gentler than the gradient of the power-supply voltage Vin3, the OBPs 131 and 132 cannot trace (follow) the gradient of the power-supply voltage Vin3. Therefore, it is impossible to equalize the gradients of the power-supply voltages Vin1 to Vin3. At this time, if the level of the power-supply voltage Vin3 is lower than the level of the power-supply voltage Vin2, the power-supply voltage Vin2 is clamped, so that the OBP 132 cannot output the desired voltage.

As explained above, in order to equalize the gradients of the power-supply voltages Vin1 to Vin3 outputted from the OBPs 131 to 133 having the tracing function, it is necessary to satisfy the aforementioned conditions 1 and 2, i.e., the power-supply voltage outputted from one of the OBPs is required to have the gentlest gradient and reach the highest level. In the example of FIG. 19, the power-supply voltage Vin3, which reaches the highest level, is required to have the gentlest gradient.

As explained above, conventionally, it is impossible to supply different power-supply voltages to a load so as to equalize the gradients, according to the condition of a power-supply voltage which is traced.

Further, another power-supply device has been conventionally proposed. In the power-supply device, the output voltage of a switching power supply is controlled so as to speedily reach a target value, and overshooting and undershooting are suppressed. See, for example, Japanese Unexamined Patent Publication No. 2004-297983. However, the proposed power-supply device does not overcome the explained problem.

### SUMMARY OF THE INVENTION

The present invention is made in view of the above problems.

The object of the present invention is to provide a power supply system which can output a plurality of power-supply voltages so as to have an identical gradient regardlessly of the condition of the power-supply voltages.

In order to accomplish the above object, a power supply system for supplying a plurality of power-supply voltages to a load is provided. The power supply system comprises: a plurality of voltage output units which output the plurality of power-supply voltages; a gradient calculation unit which calculates the gradients of the plurality of power-supply voltages in intervals subsequent to certain moments immediately after the beginnings of rises of the plurality of power-supply voltages on the basis of the levels of the plurality of power-supply voltages at the moments; a gradient extraction unit which extracts the gentlest one of the gradients; and a power-supply control unit which controls the plurality of voltage output units so that the plurality of power-supply voltages rise with the gentlest one of the gradients.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

FIG. 1 is a diagram illustrating an outline of the power supply system according to the present invention.

FIG. 2 is a circuit diagram illustrating a configuration in which a power supply system according to a first embodiment of the present invention is used.

FIG. 3 is a diagram illustrating examples of rises of power-supply voltages according to the first embodiment.

FIG. 4 is a diagram illustrating examples of rises of power-supply voltages according to the first embodiment in the case where starting times are specifically set.

FIG. 5 is a circuit diagram illustrating an example of an isolated OBP used in the configuration of FIG. 16.

FIG. 6 is a circuit diagram illustrating an example of an isolated-OBP bus converter used in the configuration of FIG. 16.

FIG. 7 is a circuit diagram illustrating an example of a non-isolated OBP used in the configuration of FIG. 16.

FIG. 8 is a circuit diagram illustrating an example of an isolated OBP for use in the configuration of FIG. 2.

FIG. 9 is a circuit diagram illustrating an example of an isolated-OBP bus converter for use in the configuration of FIG. 2.

FIG. 10 is a circuit diagram illustrating an example of a non-isolated OBP for use in the configuration of FIG.

FIG. 11 is a diagram illustrating the functions of a common control unit which can control all of the isolated OBP, the isolated-OBP bus converter, and the non-isolated OBP.

FIG. 12 is a diagram for explaining sampling of a power-supply voltage.

FIG. 13 is a diagram for explaining calculation of a gradient.

FIG. 14 is a diagram for explaining operations of the power supply system according to the first embodiment.

FIG. 15 is a diagram for explaining operations of a power supply system according to a second embodiment.

FIG. 16 is a diagram illustrating an example of a circuit configuration for supplying a plurality of power-supply voltages to a load which needs such power-supply voltages.

FIG. 17 is a diagram for explaining starting times of the power-supply voltages.

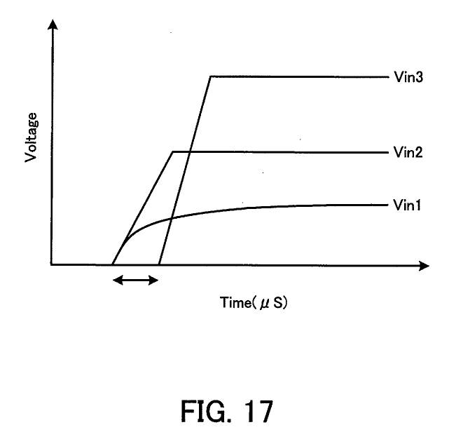

FIG. 18 is a diagram illustrating an example of a circuit in which OBPs have a tracing function.

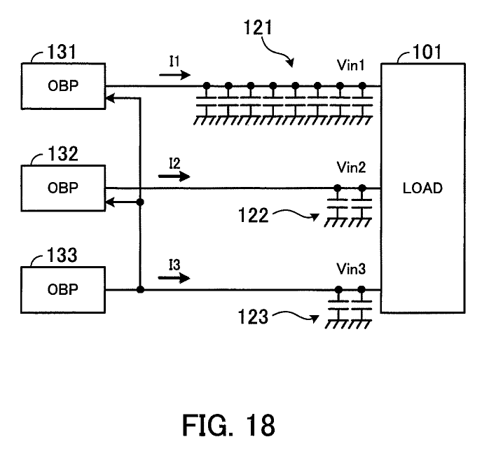

FIG. 19 is a diagram for explaining the tracing function.

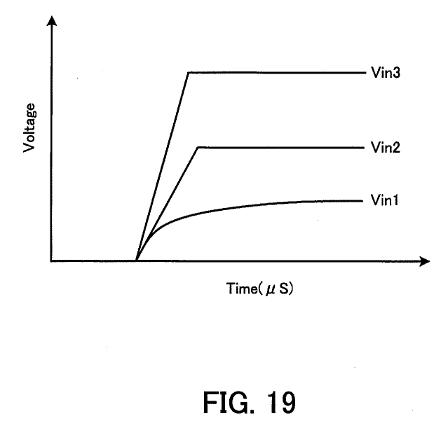

### DESCRIPTION OF THE PREFERRED EMBODIMENTS

Preferred embodiments of the present invention will be explained below with reference to the accompanying drawings, wherein like reference numbers refer to like elements throughout.

### 1. Principle of the Present Invention

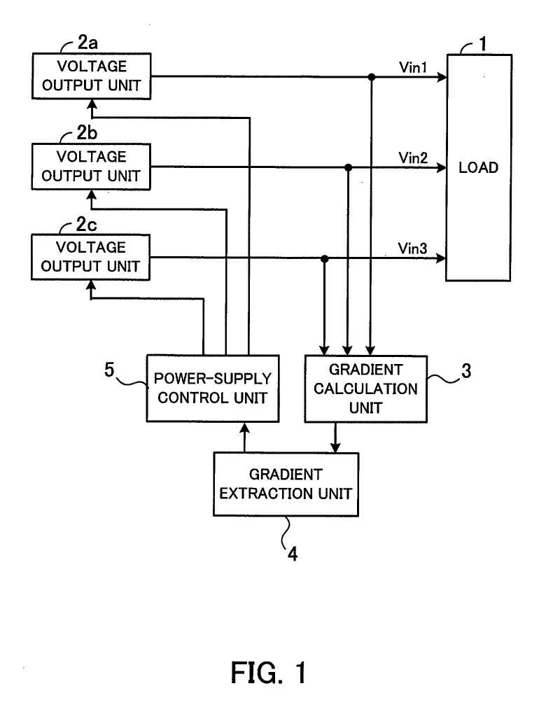

First, the principle of the present invention is explained below with reference to FIG. 1, which is a diagram illustrating an outline of the power supply system according to the present invention. In the following explanations, it is assumed, for simple explanation, that the number of power-supply voltages supplied to a load is three. As indicated in FIG. 1, the power supply system according to the present invention comprises a plurality of voltage output units 2a to 2c, a gradient calculation unit 3, a gradient extraction unit 4, and a power-supply control unit 5. In addition, the load 1 is indicated in FIG. 1.

The voltage output units 2a to 2c output a plurality of power-supply voltages Vin1, Vin2, and Vin3 to the load 1.

The gradient calculation unit 3 calculates the gradients A, B, and C of the power-supply voltages Vin1, Vin2, and Vin3 in intervals subsequent to first moments immediately after the beginnings of rises of the power-supply voltages Vin1, Vin2, and Vin3 (until second moments at which the power-supply voltages Vin1, Vin2, and Vin3 are stabilized at the levels specified for (required by) the load 1), on the basis of the levels of the power-supply voltages Vin1, Vin2, and Vin3 at the first moments.

The gradient extraction unit 4 extracts the gentlest one of the gradients calculated by the gradient calculation unit 3. For example, in the case where the gradients A, B, and C of the power-supply voltages Vin1, Vin2, and Vin3 satisfy the inequalities, A>B>C, the gradient C of the power-supply voltage Vin3 is gentlest, and is therefore extracted by the gradient extraction unit 4.

The power-supply control unit 5 controls the voltage output units 2a to 2c so that the power-supply voltages Vin1, Vin2, and Vin3 (outputted from the voltage output units 2a to 2c) rise with the gradient extracted by the gradient extraction unit 4. For example, in the case where the gradients A, B, and C of the power-supply voltages Vin1, Vin2, and Vin3 satisfy the inequalities, A>B>C, the power-supply control unit 5 controls the voltage output units 2a and 2b so that the power-supply voltages Vin1 and Vin2 rise with the gradient C.

As explained above, according to the present invention, the gradients A, B, and C of the power-supply voltages Vin1, Vin2, and Vin3 in the intervals subsequent to the (first) moments immediately after the beginnings of rises of the power-supply voltages Vin1, Vin2, and Vin3 are calculated on the basis of the levels of the power-supply voltages Vin1, Vin2, and Vin3 at the (first) moments. Then, the gentlest one of the gradients calculated by the gradient calculation unit 3 is extracted, and the voltage output units 2a to 2c are controlled so that the power-supply voltages Vin1, Vin2, and Vin3 (outputted from the voltage output units 2a to 2c) rise with the extracted gradient. Therefore, it is possible to output the power-supply voltages Vin1, Vin2, and Vin3 so that the gradients A, B, and C of the power-supply voltages Vin1, Vin2, and Vin3 are equalized regardlessly of the condition of the power-supply voltages. That is, the gradients A, B, and C of the power-supply voltages Vin1, Vin2, and Vin3 can be equalized without satisfying the aforementioned conditions 1 and 2 (i.e., the condition that the power-supply voltage outputted from one of the OBPs (on-board power supplies) is required to have the gentlest gradient and reach the highest level). For example, in the case where the gradients A, B, and C of the power-supply voltages Vin1, Vin2, and Vin3 satisfy the inequalities, A>B>C, the gradients A and B of the power-supply voltages Vin1 and Vin2 are equalized with the gradient C of the power-supply voltage Vin3. However, it is unnecessary that the level of the power-supply voltage Vin3 be the highest among the power-supply voltages Vin1, Vin2, and Vin3.

### 2. First Embodiment

Next, the first embodiment of the present invention is explained in detail below.

### 2.1 Construction of First Embodiment

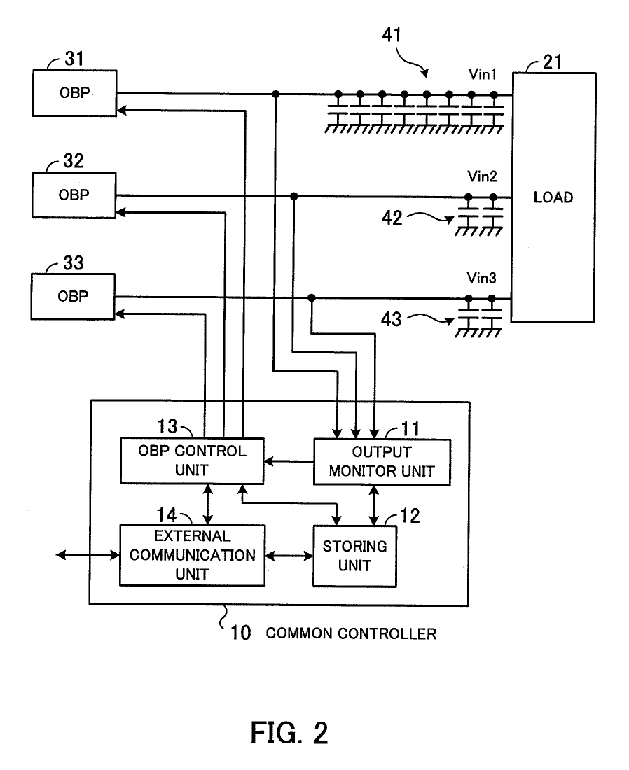

FIG. 2 is a circuit diagram illustrating a configuration in which a power supply system according to the first embodiment of the present invention is used. The power supply system illustrated in FIG. 2 comprises a common controller 10 and a plurality of OBPs 31 to 33, and supplies a plurality of power-supply voltages Vin1, Vin2, and Vin3 to a load 21.

Each of the OBPs 31 to 33 is realized, for example, by a one-chip semiconductor device. The OBPs 31 to 33 respectively supply the power-supply voltages Vin1, Vin2, and Vin3 to the load 21, and the gradients of the power-supply voltages Vin1, Vin2, and Vin3 outputted from the OBPs 31 to 33 are controlled by the common controller 10.

The load 21 is a semiconductor device such as an FPGA (Field Programmable Gate Array), and operates when electric power from a plurality of power supplies is supplied to the load 21. In this example, it is assumed that the load 21 operates when the power-supply voltages Vin1, Vin2, and Vin3 are supplied to the load 21, the power-supply voltages Vin1, Vin2, and Vin3 satisfy the inequalities, Vin1<Vin2<Vin3, and the starting times of the power-supply voltages Vin1, Vin2, and Vin3 are specified (required) so that the power-supply voltages Vin1, Vin2, and Vin3 rise (i.e., reach desired levels) in the order of Vin1, Vin2, and Vin3. The load 21 has power-input terminals, to which groups 41, 42, and 43 of capacitance are connected, respectively.

The common controller 10 comprises an output monitor unit 11, a storing unit 12, an OBP control unit 13, and an external communication unit 14. The common controller 10 is realized, for example, by a semiconductor device.

The output monitor unit 11 receives the power-supply voltages Vin1, Vin2, and Vin3, which are outputted from the OBPs 31 to 33 to the load 21. The output monitor unit 11 monitors the levels of the power-supply voltages Vin1, Vin2, and Vin3 at first moments immediately after the beginnings of rises of the power-supply voltages Vin1, Vin2, and Vin3 (e.g., immediately after power on of the OBPs 31 to 33), and calculates the gradients A, B, and C of the power-supply voltages Vin1, Vin2, and Vin3 in the intervals after the first moments (until second moments at which the power-supply voltages Vin1 to Vin3 respectively reach preset levels specified for (required by) the load 21), on the basis of the levels of the power-supply voltages Vin1, Vin2, and Vin3 at the first moments. Then, the output monitor unit 11 extracts the gentlest one of the gradients calculated by the gradient calculation unit 3, and outputs the extracted gradient to the OBP control unit 13.

In addition, the output monitor unit 11 detects the differences between the power-supply voltages Vin1, Vin2, and Vin3 and the respectively corresponding preset levels, and outputs the differences to the OBP control unit 13. Thus, it is possible to control the power-supply voltages Vin1, Vin2, and Vin3 so as to be maintained at the respectively corresponding preset levels. Further, the output monitor unit 11 outputs an alarm signal when at least one of the above differences exceeds a predetermined value.

Furthermore, the output monitor unit 11 memorizes information on the operations of the OBPs 31 to 33 in the storing unit 12. For example, the memorized information includes the outputted levels of the power-supply voltages Vin1, Vin2, and Vin3, the calculated gradients, the gentlest one of the calculated gradients, and information on one of the OBPs 31 to 33 which outputs the gentlest gradient. The storing unit 12 is realized, for example, by a storage device such as a RAM (random access memory) or a flash memory.

The OBP control unit 13 controls the output from the OBPs 31 to 33 of the power-supply voltages Vin1, Vin2, and Vin3. For example, the OBP control unit 13 controls the output voltages of the OBPs 31 to 33 by varying pulse widths of control signals supplied to the OBPs 31 to 33 as explained later.

Specifically, when the power-supply voltages Vin1, Vin2, and Vin3 outputted from the OBPs 31 to 33 rise, the OBP control unit 13 controls the OBPs 31 to 33 so that the power-supply voltages Vin1, Vin2, and Vin3 rise with the gentlest one of the calculated gradients which is extracted by the output monitor unit 11. In addition, after each of the power-supply voltages Vin1, Vin2, and Vin3 reaches the preset level for the power-supply voltage, the difference between the power-supply voltage and the preset level, which is outputted from the output monitor unit 11, is maintained zero. That is, the common controller 10 performs feedback control so that the power-supply voltages Vin1, Vin2, and Vin3 are maintained at the preset levels for the power-supply voltages Vin1, Vin2, and Vin3, respectively.

The external communication unit 14 performs communication with a personal computer (PC) or a CPU (central processing unit) which controls the entire circuit of FIG. 2. In addition, the external communication unit 14 stores setting information in the storing unit 12, where the setting information is set in the common controller 10 by the PC or CPU. The OBP control unit 13 operates in accordance with the setting information stored in the storing unit 12. For example, the setting information indicates the starting times and the preset levels of the power-supply voltages Vin1, Vin2, and Vin3.

For example, in the case where the starting times of the power-supply voltages Vin1, Vin2, and Vin3 are set in the storing unit 12 as above, the OBP control unit 13 controls the OBPs 31 to 33 so that the power-supply voltages Vin1, Vin2, and Vin3 are outputted at the starting times. In many cases, the specifications for loads require that OBPs be successively started in increasing order of voltage.

In addition, the external communication unit 14 outputs to the PC or CPU the information on the operations of the OBPs 31 to 33 which is stored in the storing unit 12, alarm information, and the like.

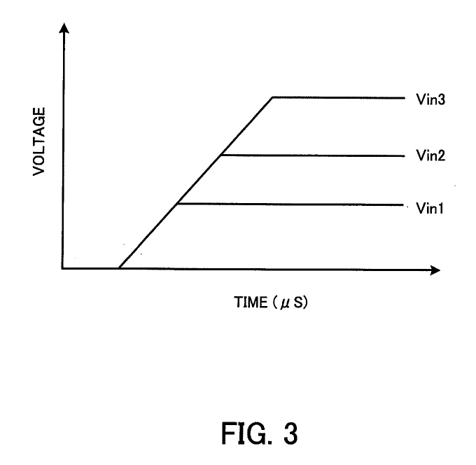

FIG. 3 is a diagram illustrating examples of rises of the power-supply voltages according to the first embodiment.

The output monitor unit 11 extracts the gentlest one of the gradients of the power-supply voltages Vin1, Vin2, and Vin3, and the OBP control unit 13 controls the OBPs 31 to 33 so that the power-supply voltages Vin1, Vin2, and Vin3 rise with the gentlest gradient. Therefore, after the OBPs 31 to 33 are powered on, the power-supply voltages Vin1, Vin2, and Vin3 are outputted with the gentlest (identical) gradient as indicated in FIG. 3.

As explained above, according to the first embodiment, it is possible to equalize the gradients of the power-supply voltages Vin1, Vin2, and Vin3 regardlessly of the levels of the power-supply voltages Vin1, Vin2, and Vin3 by equalizing the gradients of the power-supply voltages Vin1, Vin2, and Vin3 with the gentlest one of the calculated gradients of the power-supply voltages Vin1, Vin2, and Vin3. That is, it is unnecessary to satisfy the aforementioned conditions 1 and 2 (i.e., the condition that the power-supply voltage outputted from one of the OBPs (on-board power supplies) is required to have the gentlest gradient and reach the highest level) for equalizing the gradients of the power-supply voltages Vin1, Vin2, and Vin3.

Since the gradients of the power-supply voltages Vin1, Vin2, and Vin3 are equalized, when the OBPs 31 to 33 are started at the same time, the power-supply voltages Vin1, Vin2, and Vin3 successively reach the preset levels in increasing order of voltage (i.e., in the order of Vin1, Vin2, and Vin3). Therefore, in the case where the specification for the load 21 requires that the OBPs 31 to 33 be successively started in increasing order of voltage, the requirement can be satisfied by simply starting the OBPs 31 to 33 at the same time. Further, it is possible to vary the equalized gradients within a range not exceeding the gentlest gradient extracted by the output monitor unit 11, while maintaining the equality of the gradients.

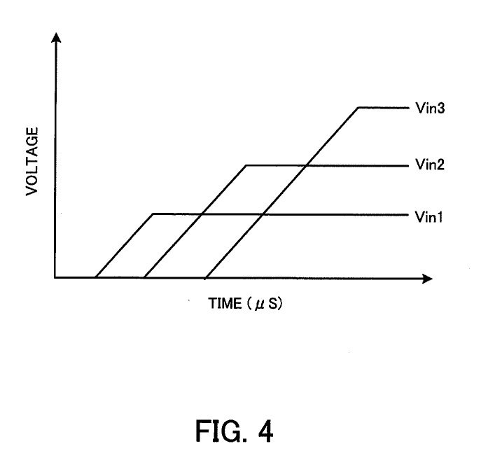

FIG. 4 is a diagram illustrating examples of rises of power-supply voltages according to the first embodiment in the case where the starting times are specifically set. In the case where the starting times are specifically set by the PC or CPU, the OBP control unit 13 controls the OBPs 31 to 33 so that the gradients of the power-supply voltages Vin1, Vin2, and Vin3 are equalized with the gentlest gradient extracted by the output monitor unit 11, and the power-supply voltages Vin1, Vin2, and Vin3 are outputted in the order set by the PC or CPU. In the case where the specification for the load 21 requires that the OBPs 31 to 33 be successively started in decreasing order of voltage, the requirement can be satisfied by the setting of the starting times.

As explained above, it is possible to start the outputs of the power-supply voltages Vin1, Vin2, and Vin3 at the respectively corresponding starting times which are specifically set by the PC or CPU, and make the power-supply voltages Vin1, Vin2, and Vin3 rise with an identical gradient.

However, it is necessary to calculate the gradients of the power-supply voltages Vin1, Vin2, and Vin3 before the outputs of the power-supply voltages Vin1, Vin2, and Vin3 are respectively started at the starting times set by the PC or CPU, because if the gradients of the power-supply voltages Vin1, Vin2, and Vin3 are not calculated in advance, the gentlest gradient cannot be extracted, i.e., the gradient with which the power-supply voltages Vin1, Vin2, and Vin3 should rise cannot be obtained. Therefore, it is necessary to calculate the power-supply voltages Vin1, Vin2, and Vin3 by starting up the power supply system without setting the starting times, and memorize the calculated power-supply voltages in the storing unit 12, before supplying the power-supply voltages Vin1, Vin2, and Vin3 to the load 21 for actual use. Alternatively, the power-supply voltages Vin1, Vin2, and Vin3 may be obtained in a test mode as explained later in the second embodiment.

### 2.2 OBPs

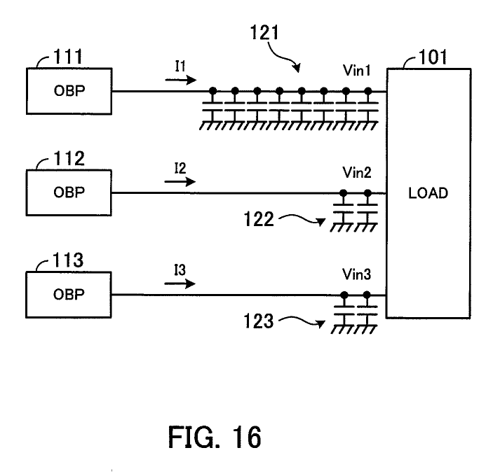

Next, the constructions and operations of the OBPs are explained. Before explaining the OBPs 31 to 33 in the configuration of FIG. 2, the constructions and operations of the OBPs 111 to 113 in the configuration of FIG. 16 are explained below for comparison. Each of the OBPs 111 to 113 may be an isolated OBP, an isolated-OBP bus converter, or a non-isolated OBP.

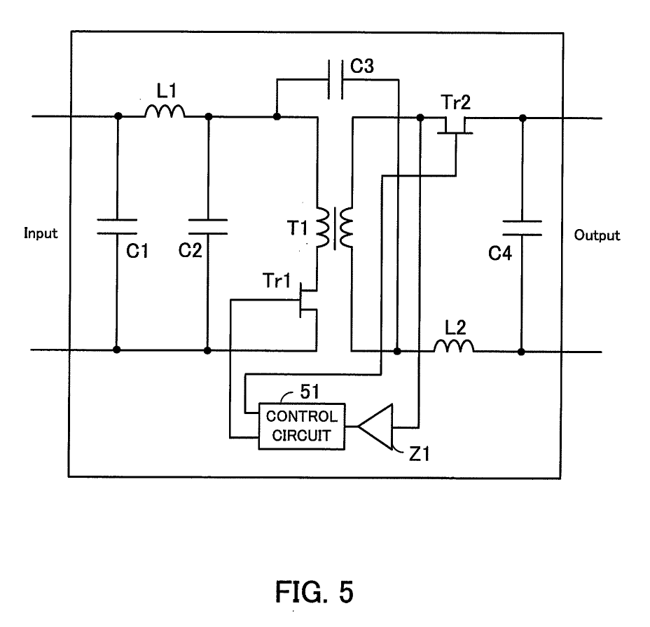

FIG. 5 is a circuit diagram illustrating an example of an isolated OBP used in the configuration of FIG. 16. The isolated OBP of FIG. 5 comprises capacitances C1 to C4, coils L1 and L2, a transformer T1, transistors Tr1 and Tr2, an operational amplifier Z1, and a control circuit 51. In the isolated OBP of FIG. 5, the input and output are isolated by the transformer T1. In the isolated OBP, the control circuit 51 controls the widths of pulsed voltages applied to the transistors Tr1 and Tr2, according to the output voltage of the transformer T1. Therefore, it is possible to control the magnitude of the voltage outputted from the isolated OBP.

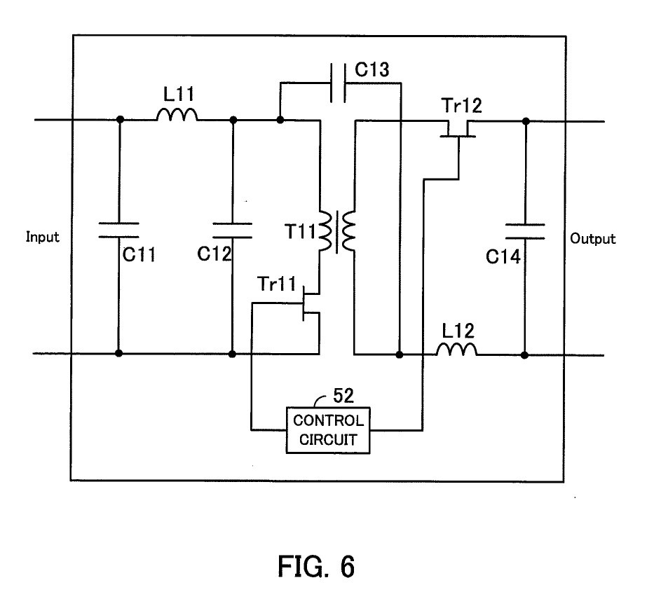

FIG. 6 is a circuit diagram illustrating an example of an isolated-OBP bus converter used in the configuration of FIG. 16. The isolated-OBP bus converter of FIG. 6 comprises capacitances C11 to C14, coils L11 and L12, a transformer T11, transistors Tr11 and Tr12, and a control circuit 52. In the isolated-OBP bus converter, the input and output are isolated by the transformer T11. In the isolated-OBP bus converter of FIG. 6, the control circuit 52 controls the widths of pulsed voltages applied to the transistors Tr11 and Tr12 so that the ratio of the output voltage to the input voltage of the isolated-OBP bus converter becomes a predetermined value (1/n). Therefore, the isolated-OBP bus converter outputs the output voltage the ratio of which to the input voltage is the predetermined value.

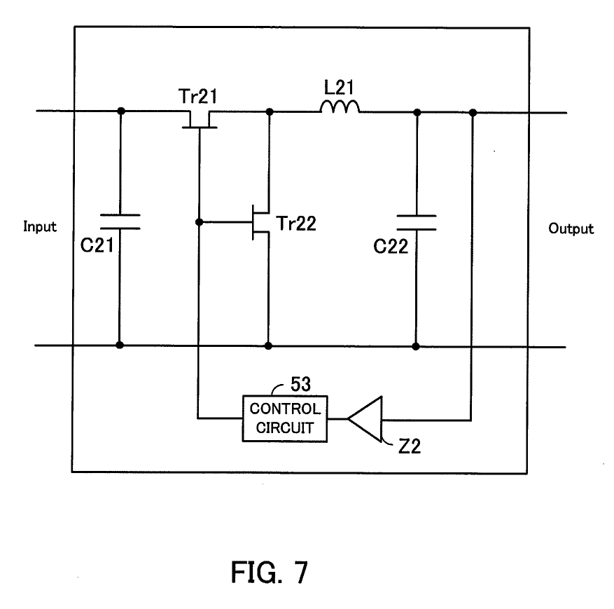

FIG. 7 is a circuit diagram illustrating an example of a non-isolated OBP used in the configuration of FIG. 16. The non-isolated OBP of FIG. 7 comprises capacitances C21 and C22, a coil L21, transistors Tr21 and Tr22, an operational amplifier Z2, and a control circuit 53. In the non-isolated OBP, the input and output are not isolated by a transformer as in the isolated OBP of FIG. 5 or the isolated-OBP bus converter of FIG. 6. In the non-isolated OBP of FIG. 7, the control circuit 53 controls the widths of pulsed voltages applied to the transistors Tr21 and Tr22, according to the output voltage of the non-isolated OBP. Therefore, it is possible to control the magnitude of the voltage outputted from the non-isolated OBP.

Next, the constructions and operations of the OBPs 31 to 33 in the configuration of FIG. 2 are explained below for comparison. Each of the OBPs 31 to 33 may also be an isolated OBP, an isolated-OBP bus converter, or a non-isolated OBP.

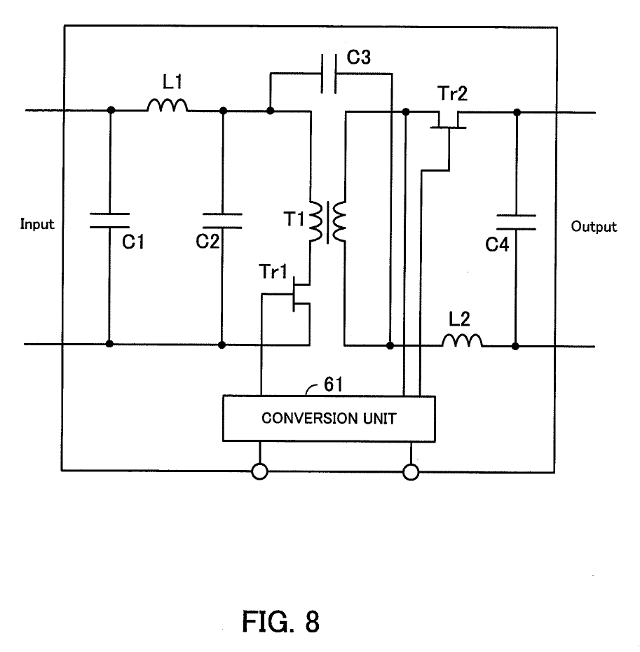

FIG. 8 is a circuit diagram illustrating an example of an isolated OBP for use in the configuration of FIG. 2. In FIG. 8, the same elements as the corresponding elements in FIG. 5 respectively bear the same reference numbers as in FIG. 5. The isolated OBP of FIG. 8 is different from the isolated OBP of FIG. 5 in that the isolated OBP of FIG. 8 does not comprise the operational amplifier Z1 and the control circuit 51, and instead comprises a conversion unit 61. The conversion unit 61 performs analog-to-digital (A/D) conversion of the output voltage of the isolated OBP, and outputs the digital value indicating the output voltage to the common controller 10 in FIG. 2. In addition, the conversion unit 61 receives a digital signal outputted from the common controller 10, performs digital-to-analog (D/A) conversion of the received digital signal, and outputs the D/A converted signal to the transistors Tr1 and Tr2. At this time, the common controller 10 controls the widths of pulsed voltages applied to the transistors Tr1 and Tr2, according to the output voltage of the transformer T1 so that the isolated OBP of FIG. 8 outputs a desired voltage. That is, in the case where the isolated OBP of FIG. 8 is used as each of the OBPs 31 to 33 in the configuration of FIG. 2, the common controller 10 performs the functions corresponding to the operational amplifier Z1 and the control circuit 51 in FIG. 5.

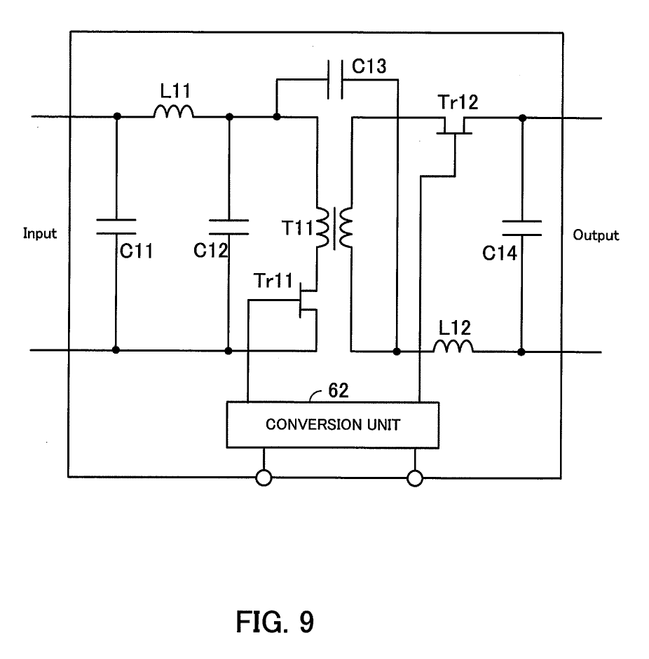

FIG. 9 is a circuit diagram illustrating an example of an isolated-OBP bus converter for use in the configuration of FIG. 2. In FIG. 9, the same elements as the corresponding elements in FIG. 6 respectively bear the same reference numbers as in FIG. 6. The isolated-OBP bus converter of FIG. 9 is different from the isolated-OBP bus converter of FIG. 6 in that the isolated-OBP bus converter of FIG. 9 does not comprise the control circuit 52, and instead comprises a conversion unit 62. The conversion unit 62 receives a digital signal outputted from the common controller 10, performs digital-to-analog (D/A) conversion of the received digital signal, and outputs the D/A converted signal to the transistors Tr11 and Tr12. At this time, the common controller 10 controls the widths of pulsed voltages applied to the transistors Tr1 and Tr2 so that the ratio of the output voltage to the input voltage of the isolated-OBP bus converter becomes a predetermined value (1/n). That is, in the case where the isolated-OBP bus converter of FIG. 9 is used as each of the OBPs 31 to 33 in the configuration of FIG. 2, the common controller 10 performs the functions corresponding to the control circuit 52 in FIG. 6.

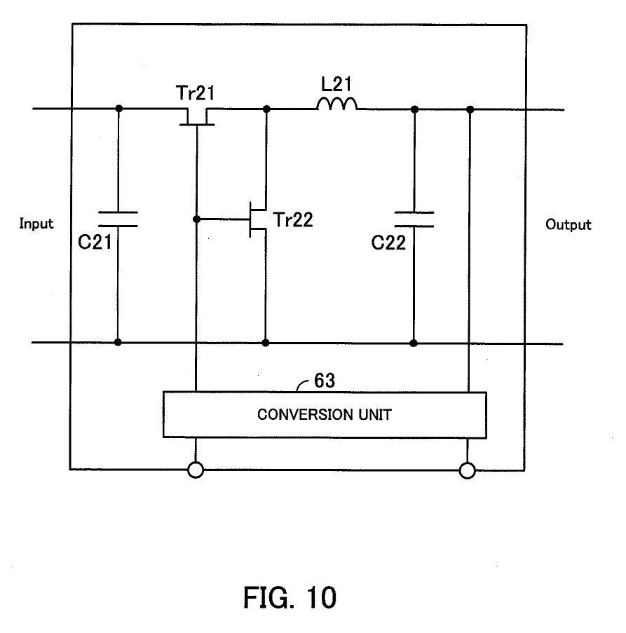

FIG. 10 is a circuit diagram illustrating an example of a non-isolated OBP for use in the configuration of FIG. 2. In FIG. 10, the same elements as the corresponding elements in FIG. 7 respectively bear the same reference numbers as in FIG. 7. The non-isolated OBP of FIG. 10 is different from the non-isolated OBP of FIG. 7 in that the non-isolated OBP of FIG. 10 does not comprise the operational amplifier Z2 and the control circuit 53, and instead comprises a conversion unit 63. The conversion unit 63 performs analog-to-digital (A/D) conversion of the output voltage of the non-isolated OBP, and outputs the digital value indicating the output voltage to the common controller 10 in FIG. 2. In addition, the conversion unit 63 receives a digital signal outputted from the common controller 10, performs digital-to-analog (D/A) conversion of the received digital signal, and outputs the D/A converted signal to the transistors Tr21 and Tr22. At this time, the common controller 10 controls the widths of pulsed voltages applied to the transistors Tr21 and Tr22, according to the output voltage of the non-isolated OBP of FIG. 10 so that the non-isolated OBP outputs a desired voltage. That is, in the case where the non-isolated OBP of FIG. 10 is used as each of the OBPs 31 to 33 in the configuration of FIG. 2, the common controller 10 performs the functions corresponding to the operational amplifier Z2 and the control circuit 53 in FIG. 7.

Further, it is unnecessary that all of the OBPs 31 to 33 in the configuration of FIG. 2 are identical types. For example, the OBPs 31 to 33 are respectively an isolated OBP (as illustrated in FIG. 8), an isolated-OBP bus converter (as illustrated in FIG. 9), and a non-isolated OBP (as illustrated in FIG. 10). In this case, the output monitor unit 11 and the OBP control unit 13 in the common controller 10 have the functions corresponding to the operational amplifiers Z1 and Z2 and the controllers 51 to 53 indicated in FIGS. 5 to 8, so that the common controller 10 can control the different types of OBPs in the configuration of FIG. 2.

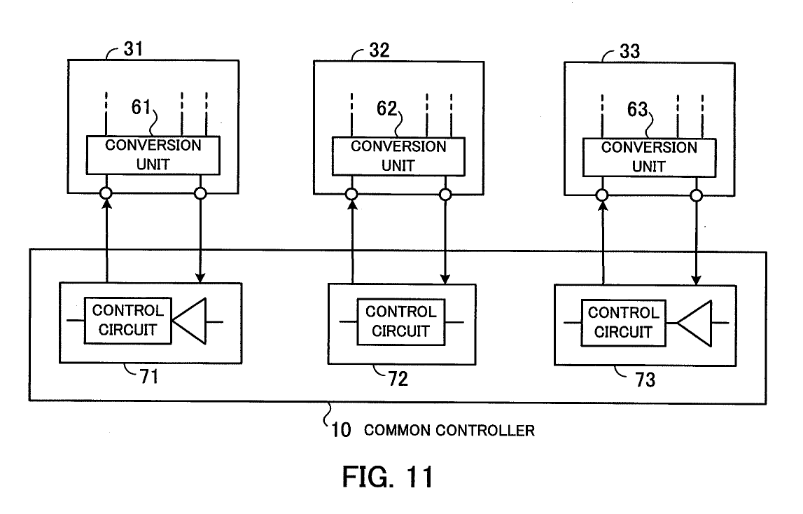

FIG. 11 is a diagram illustrating the functions of the common control unit 10 which can control all of the isolated OBP, the isolated-OBP bus converter, and the non-isolated OBP. FIG. 11 also shows the OBPs 31 to 33 controlled by the common controller 10. In FIG. 11, it is assumed that the OBPs 31 to 33 are respectively an isolated OBP, an isolated-OBP bus converter, and a non-isolated OBP, and the conversion units 61 to 63 in the isolated OBP, the isolated-OBP bus converter, and the non-isolated OBP (which are explained with reference to FIGS. 8 to 10) are respectively indicated in the blocks of the OBPs 31 to 33.

The common controller 10 of FIG. 11 comprises control units 71 to 73 respectively for controlling the isolated OBP, the isolated-OBP bus converter, and the non-isolated OBP. The control units 71 to 73 respectively have the functions of the controllers 51 to 53. Further, the control units 71 and 73 respectively have the functions of the operational amplifiers Z1 and Z2. For example, the common controller 10 is realized by a digital signal processor (DSP), and performs digital processing for realizing the above functions.

Since the voltages outputted from the OBPs 31 to 33 are digitally controlled by the common controller 10 in a centralized manner as explained above, it is possible to reduce the areas and the cost of the OBPs 31 to 33. Further, in the case where the interfaces between the OBPs 31 to 33 and the common controller 10 are digitized, it is possible to suppress noise influence and facilitate wire routing.

### 2.3 Calculation of Gradients

Next, the calculation of the gradients performed by the output monitor unit 11 is explained below.

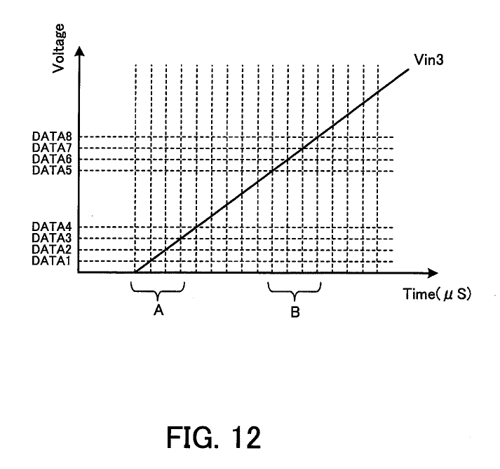

The output monitor unit 11 samples data of each of the power-supply voltages Vin1, Vin2, and Vin3 immediately after the beginning of the rise of the power-supply voltage at a predetermined sampling rate. FIG. 12 is a diagram for explaining sampling of a power-supply voltage, and shows a waveform immediately after the beginning of the rise of the power-supply voltage Vin3. For example, the output monitor unit 11 samples data “DATA1,” “DATA2,” “DATA3,” and “DATA4” of the power-supply voltage Vin3 in the sampling-time range A and data “DATA5,” “DATA6,” “DATA7,” and “DATA8” in the sampling-time range B. The OBPs 31 to 33 output to the common controller 10 the power-supply voltages Vin1, Vin2, and Vin3 in digital forms, so that the data “DATA1,” “DATA2,” “DATA3,” “DATA4,” “DATA5,” “DATA6,” “DATA7,” and “DATA8” sampled by the output monitor unit 11 are digital data.

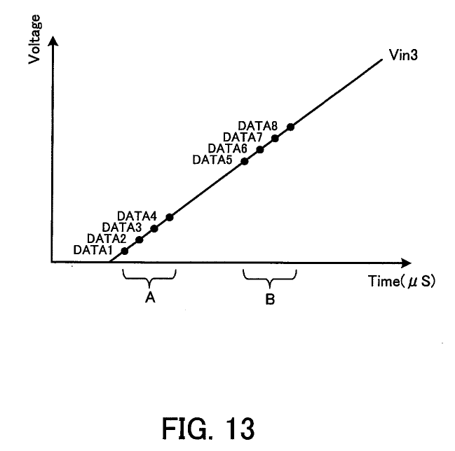

FIG. 13 is a diagram for explaining calculation of a gradient, and shows a gradient of the power-supply voltage Vin3 which is calculated on the basis of the data “DATA1,” “DATA2,” “DATA3,” “DATA4,” “DATA5,” “DATA6,” “DATA7,” and “DATA8” sampled in the sampling-time ranges A and B. The output monitor unit 11 calculates the gradient of FIG. 13.

For example, the output monitor unit 11 calculates a first straight line that approximately or exactly passes through the points corresponding to the data “DATA1,” “DATA2,” “DATA3,” and “DATA4,” and obtains the gradient of the first straight line as a first gradient. Then, the output monitor unit 11 calculates a second straight line that approximately or exactly passes through the points corresponding to the data “DATA5,” “DATA6,” “DATA7,” and “DATA8,” and obtains the gradient of the second straight line as a second gradient. Finally, the output monitor unit 11 calculates an average of the first and second gradients as the gradient of the power-supply voltage Vin3.

Since the gradient is calculated on the basis of a plurality of samples in the sampling-time ranges A and B, the accuracy of the calculation is increased. Although samples in two sampling-time ranges are used in the above example, the number of sampling-time ranges used for calculation of the gradient may be one, or three or more. Further, although four samples in each sampling-time range are used for calculating a gradient in the above example, the number of samples in each sampling-time range used for calculating a gradient may be any number greater than one since each gradient can be determined on the basis of at least two samples.

In order to quickly equalize the gradients of the power-supply voltages Vin1, Vin2, and Vin3, it is desirable that each sampling-time range is a time range immediately after power on of the corresponding OBP (i.e., a short time range immediately after the beginning of a rise of the corresponding power-supply voltage).

### 2.4 Operations of First Embodiment

Hereinbelow, operations of the power supply system according to the first embodiment illustrated in FIG. 2 are explained below.

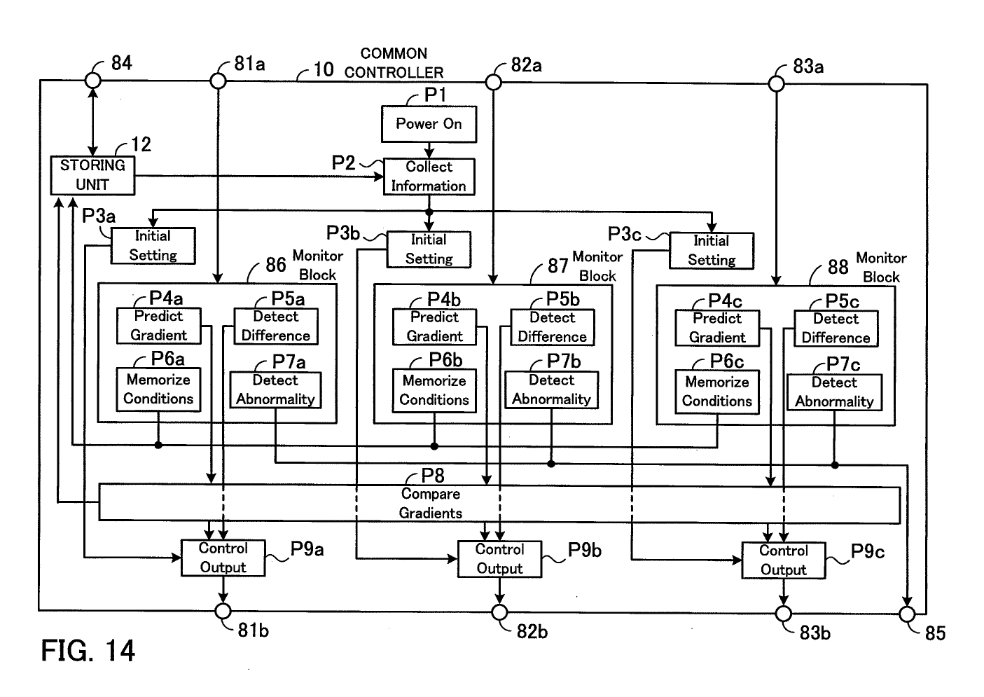

FIG. 14 is a diagram for explaining the operations of the power supply system according to the first embodiment. In FIG. 14, 81a to 83a, 81b to 83b, 84, and 85 each denote a terminal which the common controller 10 has, and 86, 87, and 88 each denote a monitor block.

The terminal 81a is connected to the OBP 31, and the power-supply voltage Vin1 is inputted into the common controller 10 through the terminal 81a. The terminal 82a is connected to the OBP 32, and the power-supply voltage Vin2 is inputted into the common controller 10 through the terminal 82a. The terminal 83a is connected to the OBP 33, and the power-supply voltage Vin3 is inputted into the common controller 10 through the terminal 83a.

The terminal 81b is connected to the OBP 31, and signals for controlling the OBP 31 are outputted from the common controller 10 through the terminal 81b. The terminal 82b is connected to the OBP 32, and signals for controlling the OBP 32 are outputted from the common controller 10 through the terminal 82b. The terminal 83b is connected to the OBP 33, and signals for controlling the OBP 33 are outputted from the common controller 10 through the terminal 83b. The terminal 84 is connected to the PC or CPU, and the alarm signal is outputted from the common controller 10 through the terminal 85.

The monitor block 86 is a block for performing processing for the OBP 31, the monitor block 87 is a block for performing processing for the OBP 32, and the monitor block 88 is a block for performing processing for the OBP 33.

When the power supply system is powered on in the process step P1, the common controller 10 collects information from the storing unit 12 in the process step P2. For example, the common controller 10 collects from the storing unit 12 information on the preset levels, the starting times, and the starting gradients of the power-supply voltages Vin1, Vin2, and Vin3. The common controller 10 operates in either of a first mode in which the gradients of the power-supply voltages Vin1, Vin2, and Vin3 are equalized with the gentlest gradient, and a second mode in which the gradients of the power-supply voltages Vin1, Vin2, and Vin3 are not equalized with the gentlest gradient. The starting gradients are set during the second mode. The above information collected in the process step P2 is written in advance in the storing unit 12 by the PC or CPU.

When the common controller 10 collects the information as above, the common controller 10 performs initial setting for output control of the OBPs 31 to 33 on the basis of the collected information in the process steps P3a to P3c and P9a to P9c. For example, initial setting of the preset levels, the starting times, and the starting gradients is performed.

In the process steps P4a to P4c, the common controller 10 performs prediction of the gradients of the power-supply voltages Vin1, Vin2, and Vin3 after power on.

In the process step P8, the common controller 10 compares the gradients of the power-supply voltages Vin1, Vin2, and Vin3 calculated in the process steps P4a to P4c in the monitor blocks 86 to 88, and extracts the gentlest gradient.

In the process steps P9a to P9c, the common controller 10 controls the outputs from the OBPs 31 to 33 so that the power-supply voltages Vin1, Vin2, and Vin3 rise with the gradient extracted in the process step P8.

When the level of each of the power-supply voltages Vin1, Vin2, and Vin3 reaches the preset level for the power-supply voltage, the common controller 10 calculates the difference between the preset level and the current level of the power-supply voltage in the corresponding one of the process steps P5a to P5c. Then, the common controller 10 controls the output of the corresponding one of the OBPs 31 to 33 in the corresponding one of the process steps P9a to P9c so that the difference calculated in the corresponding one of the process steps P5a to P5c becomes zero.

In the process steps P7a to P7c, the common controller 10 monitors the differences between the preset levels and the current levels of the power-supply voltages.

When the difference in one of the power-supply voltages Vin1, Vin2, and Vin3 reaches a predetermined value, the common controller 10 detects the difference as an abnormality in the corresponding one of the process steps P7a to P7c, and outputs an alarm signal through the terminal 85.

Further, it is possible to connect the terminal 85 to the OBPs 31 to 33, and stop all the operations of the OBPs 31 to 33 when the common controller 10 detects an abnormality in the OBPs 31 to 33. In this case, when the common controller 10 detects an abnormality in the OBPs 31 to 33, the outputs of the power-supply voltages Vin1, Vin2, and Vin3 are stopped, so that it is possible to prevent breakdown of the load 21.

In the process steps P6a to P6c, the common controller 10 memorizes in the storing unit 12 information on successive operations of the OBPs 31 to 33, which includes the power-supply voltages Vin1, Vin2, and Vin3 outputted from the OBPs 31 to 33, the aforementioned differences, information on the detection of abnormalities, and the like.

As explained above, the power supply system calculates the gradients of the plurality of power-supply voltages Vin1, Vin2, and Vin3 on the basis of the levels of the power-supply voltages Vin1, Vin2, and Vin3 sampled immediately after the beginnings of rises of the power-supply voltages Vin1, Vin2, and Vin3, extracts the gentlest gradient, and controls the OBPs 31 to 33 so that the power-supply voltages Vin1, Vin2, and Vin3 rise with the extracted gradient. Therefore, it is possible to output the plurality of power-supply voltages Vin1, Vin2, and Vin3 with the identical gradient regardlessly of the condition of the power-supply voltages Vin1, Vin2, and Vin3.

Although the above explanations on the first embodiment are made for the rises of the power-supply voltages, it is also possible to equalize the gradients of power-supply voltages during falls of the power-supply voltages. Specifically, the falling gradient of each of the plurality of power-supply voltages immediately after a fall of the power-supply voltage (e.g., immediately after a stop of input of a voltage to the corresponding one of the OBPs 31 to 33) are calculated, and the gentlest falling gradient is extracted. Then, the OBPs 31 to 33 are controlled so that power-supply voltages outputted from the OBPs 31 to 33 fall with the extracted falling gradient.

In addition, since the information on the operations of the OBPs 31 to 33 are stored in the storing unit 12, it is possible to easily perform failure analysis and the like of the OBPs 31 to 33.

### 3. Second Embodiment

Next, the second embodiment of the present invention is explained in detail below.

The power supply system according to the second embodiment can also operate in a test mode, in which the power supply system calculates the gentlest gradient and memorizes the calculated gradient in a storage device such as a memory. When the power supply system is turned on after the operations in the test mode are completed, the power supply system controls the power-supply voltages outputted from the OBPs so that the gradients of the power-supply voltages are equalized with the memorized gradient. Therefore, according to the second embodiment, it is unnecessary to calculate the gentlest gradient again when the power supply system is turned on after the operations in the test mode are completed. Thus, the power consumption can be suppressed.

The power supply system according to the second embodiment comprises a common controller having a similar construction to the common controller 10 in the power supply system according to the first embodiment. However, the second embodiment is different from the first embodiment in that the output monitor unit 11 stores in the storing unit 12 the gentlest one of the calculated gradients of the power-supply voltages Vin1, Vin2, and Vin3 when the PC or CPU sets the test mode in the power supply system according to the second embodiment, and the power supply system according to the second embodiment controls the power-supply voltages Vin1, Vin2, and Vin3 so that the gradients of the power-supply voltages Vin1, Vin2, and Vin3 are equalized with the gentlest gradient stored in the storing unit 12 when the power supply system is turned on after the operations in the test mode are completed.

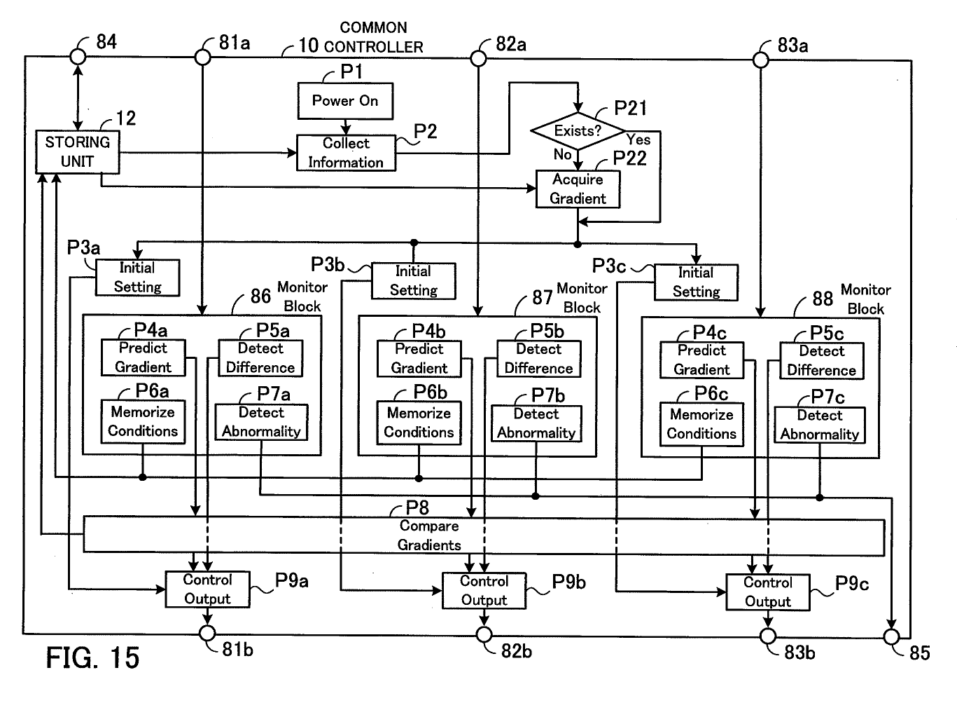

FIG. 15 is a diagram for explaining the operations of the power supply system according to the second embodiment. In FIG. 15, the same elements as the corresponding elements in FIG. 14 respectively bear the same reference numbers as in FIG. 14. The operations of the common controller 10 in the power supply system according to the second embodiment indicated in FIG. 15 include the process steps P21 and P22 in addition to the same process steps as in FIG. 14.

The PC or CPU sets the test mode in the storing unit 12 in the power supply system according to the second embodiment, for example, by writing a flag indicating the test mode in the storing unit 12.

Assume that the power supply system is powered on in the process step P1 while the test mode is set in the storing unit 12.

When the power supply system is powered on in the process step P1, the common controller 10 collects information from the storing unit 12 in the process step P2 in a similar manner to the first embodiment explained with reference to FIG. 14, and acquires the flag indicating the test mode from the storing unit 12.

In the process step P21, the common controller 10 determines whether or not the flag indicating the test mode is written in the storing unit 12. Since the flag indicating the test mode is assumed to be written in the storing unit 12 in this explanation, the common controller 10 performs initial setting in the process steps P3a to P3c in a similar manner to the first embodiment explained with reference to FIG. 14.

In the process steps P4a to P4c, the common controller 10 performs prediction of the gradients of the power-supply voltages Vin1, Vin2, and Vin3 after power on. In the process step P8, the common controller 10 compares the gradients of the power-supply voltages Vin1, Vin2, and Vin3 calculated in the process steps P4a to P4c in the monitor blocks 86 to 88, and extracts the gentlest gradient. The prediction of the gradients and the extraction of the gentlest gradient are performed in similar manners to the first embodiment explained with reference to FIG. 14. In addition, according to the second embodiment, the common controller 10 stores in the storing unit 12 the gentlest gradient extracted in the process step P8.

Further, the detection of the differences in the process steps P5a to P5c, the memorizing of the information in the process steps P6a to P6c, and the detection of abnormalities in the process steps P7a to P7c are performed in similar manners to the first embodiment explained with reference to FIG. 14.

As described above, when the power supply system is powered on during the test mode, the gentlest gradient of the power-supply voltages Vin1, Vin2, and Vin3 is memorized in the storing unit 12.

Next, the operations of the power supply system according to the second embodiment which are performed when the power supply system is powered on during a nontest (normal) mode (i.e., in the state in which the flag indicating the test mode is not written in the storing unit 12) are explained below.

In the process step P21, the common controller 10 determines that the flag indicating the test mode is not written in the storing unit 12, so that the common controller 10 acquires from the storing unit 12 the gradient which has been written in the storing unit 12 in the test mode.

Therefore, neither the calculation of the gradients in the process steps P4a to P4c nor the extraction of the gentlest gradient in the process step P8 is performed by the common controller 10 in the nontest mode. In the process steps P9a to P9c, the common controller 10 controls the outputs from the OBPs 31 to 33 during rises of the outputs on the basis of the gradient acquired in the process step P22.

In addition, the initial setting in the process steps P3a to P3c, the detection of the differences in the process steps P5a to P5c, the memorizing of the information in the process steps P6a to P6c, and the detection of abnormalities in the process steps P7a to P7c are performed in similar manners to the first embodiment explained with reference to FIG. 14.

As explained above, according to the second embodiment, in the test mode, the gradients of the power-supply voltages Vin1, Vin2, and Vin3 are calculated, and the gentlest gradient is extracted and stored in the storing unit 12. Thereafter, the calculation and extraction of the gradient are not performed during the normal mode. In the normal mode, the power-supply voltages Vin1, Vin2, and Vin3 are supplied to the load, and controlled so as to rise with the gradient memorized in the storing unit 12. Therefore, it is possible to reduce the power consumption.

### 4. Additional Matters

In the power supply system according to the present invention, the gradients of a plurality of power-supply voltages outputted from a plurality of voltage output units are calculated on the basis of the levels of the power-supply voltages sampled immediately after the beginnings of rises of the power-supply voltages, and the gentlest gradient is extracted from the calculated gradients. Then, the plurality of voltage output units are controlled so that the plurality of power-supply voltages rise with the extracted gradient. Therefore, it is possible to output the plurality of power-supply voltages with an identical gradient regardlessly of the condition of the power-supply voltages.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A power supply system for supplying a plurality of power-supply voltages to a load, comprising:
a plurality of voltage output units which output said plurality of power-supply voltages;
a gradient calculation unit which calculates gradients of said plurality of power-supply voltages in intervals subsequent to first moments immediately after beginnings of rises of the plurality of power-supply voltages on the basis of levels of the plurality of power-supply voltages at the first moments;
a gradient extraction unit which extracts a gentlest one of said gradients; and
a power-supply control unit which controls said plurality of voltage output units so that said plurality of power-supply voltages rise with said gentlest one of the gradients.

2. The power supply system according to claim 1, wherein all of said gradient calculation unit, said gradient extraction unit, and said power-supply control unit are formed in a single semiconductor device.

3. The power supply system according to claim 2, wherein said plurality of voltage output units comprise digital-signal output units which output said plurality of power-supply voltages to said semiconductor device in the forms of digital signals.

4. The power supply system according to claim 3, wherein said semiconductor device comprises a voltage control unit which controls said plurality of power-supply voltages on the basis of said digital signals.

5. The power supply system according to claim 1, further comprising,
a falling-gradient calculation unit which calculates falling gradients of said plurality of power-supply voltages in intervals subsequent to second moments immediately after beginnings of falls of the plurality of power-supply voltages on the basis of levels of the plurality of power-supply voltages at the second moments, and
a falling-gradient extraction unit which extracts a gentlest one of said falling gradients.

6. The power supply system according to claim 1, further comprising a gradient storing unit which memorizes said gentlest one of the gradients.

7. The power supply system according to claim 1, further comprising a voltage storing unit which memorizes said plurality of power-supply voltages.

8. The power supply system according to claim 1, further comprising,
an abnormality detection unit which detects an abnormality in said plurality of voltage output units, and
a voltage stop unit which stops output of said plurality of power-supply voltages from said plurality of voltage output units in response to detection of said abnormality.

9. The power supply system according to claim 1, wherein said gradient calculation unit calculates said gradients during a test mode, said gradient extraction unit extracts said gentlest one of the gradients and stores the gentlest one of the gradients in a storage device during the test mode, and acquires the gentlest one of the gradients from the storage device during a normal mode.

10. The power supply system according to claim 1, wherein said gradient calculation unit calculates said gradients by taking two or more samples of each of the plurality of power-supply voltages in one or more sampling-time ranges.

11. The power supply system according to claim 1, further comprising an output control unit which controls starting times of said plurality of power-supply voltages and said gradients in response to an external instruction.
